(19) United States
(12) Patent Application Publication
(10) Pub. No.: US 2010/0273010 A1
(43) Pub. Date: Oct. 28, 2010

(54) Silicide-coated metal surfaces and methods of utilizing same

(76) Inventors: Robert Froehlich, New Providence, NJ (US); Ben Fieselmann, Bridgewater, NJ (US); David Mixon, Port Murray, NJ (US); York Tsuo, Livingston, NJ (US)

Correspondence Address: GREENBERG TRAURIG, LLP, MET LIFE BUILDING, 200 PARK AVENUE, NEW YORK, NY, 10166, US

(21) Appl. No.: 12/661,582

(22) Filed: Mar. 19, 2010

Related U.S. Application Data
(60) Provisional application No. 61/161,686, filed on Mar. 19, 2009.

(51) Int. Cl. B32B 15/04

(52) U.S. Cl. 428/428; 428/450

(57) ABSTRACT

In an embodiment, a surface of the present invention comprises of at least one base layer, wherein the at least one base layer contains at least one silicide-forming metal element; and at least one silicide coating layer, wherein the at least one silicide coating layer is formed by a process of: i) exposing the at least one base layer having a sufficient amount of the at least one silicide-forming metal element to a sufficient amount of at least one silicon source gas having a sufficient amount of silicon element, ii) reacting the sufficient amount of the at least one silicide-forming metal element with the sufficient amount of silicon element, and iii) forming the at least one silicide coating layer.

### RELATED APPLICATIONS

This application claims the benefit of U.S. provisional application Ser. No. 61/161,686 filed Mar. 19, 2009, and entitled “SILICIDE-COATED METAL VESSEL AND METHOD OF UTILIZING SAME TO PRODUCE GRANULAR POLYSILICON” which is hereby incorporated herein by reference in the entirety for all purposes.

### BACKGROUND OF THE INVENTION

The present invention is directed to formation and use of certain surfaces that are coated with protective coatings, allowing such coated surfaces to be used in applications in which such coated surfaces may be otherwise be vulnerable to conditions, environments, and/or reactions associated with those applications.

For example, certain chemical reactions occur in environments that may have temperatures above 200 degrees Celsius, pressures significantly above the atmospheric pressure, and various corrosion agents. These environments may efficiently erode surfaces of containment structures in which the chemical reactions take place. For example, these environments may significantly reduce life expectancy such containment structures. Additionally, these environments may also negatively impact conditions and efficiencies of the chemical reactions themselves.

### BRIEF SUMMARY OF THE INVENTION

In an embodiment, a surface of the present invention comprises of at least one base layer, wherein the at least one base layer contains at least one silicide-forming metal element; and at least one silicide coating layer, wherein the at least one silicide coating layer is formed by a process of: i) exposing the at least one base layer having a sufficient amount of the at least one silicide-forming metal element to a sufficient amount of at least one silicon source gas having a sufficient amount of silicon element, ii) reacting the sufficient amount of the at least one silicide-forming metal element with the sufficient amount of silicon element, and iii) forming the at least one silicide coating layer.

In an embodiment, a surface of the present invention further comprises at least one first part of the at least one base layer is sufficiently designed to form at least one first portion of the at least one silicide coating and at least one second part of the at least one base layer is sufficiently designed to form at least one second portion of the at least one silicide coating.

In an embodiment, a surface of the present invention further comprises at least one silicide coating is sufficiently designed to withstand a substantial chemical corrosion at temperatures above 300 degrees Celsius.

In an embodiment, a surface of the present invention further comprises at least one base layer which is comprised of a ceramic material.

In an embodiment, a surface of the present invention further comprises at least one base layer which is comprised of a glass ceramic material.

In an embodiment, a surface of the present invention further comprises at least one base layer which is comprised of at least one of Al, C, Ca, Co, Cr, Cu, Fe, Mo, Si, Nb, Ni, Pt, Ti, and W.

In an embodiment, a surface of the present invention comprises a composition of the at least one silicide coating depends on a temperature at which the at least one base layer is exposed to the at least one silicon source gas.

In an embodiment, a surface of the present invention comprises at least one silicon source that is comprised of at least one of HxSiyClz, wherein x, y, and z is from 0 to 6.

In an embodiment, a surface of the present invention comprises a) at least one base layer, wherein the at least one base layer contains at least one silicide-forming metal element; b) at least one silicide coating layer, wherein the at least one silicide coating layer is formed by a first process of: i) exposing the at least one base layer having a sufficient amount of the at least one silicide-forming metal element to a sufficient amount of at least one silicon source gas having a sufficient amount of silicon element, ii) reacting the sufficient amount of the at least one silicide-forming metal element with the sufficient amount of silicon element, and iii) forming the at least one silicide coating layer; and c) at least one blocking layer.

In an embodiment, a surface of the present invention comprises at least one blocking layer is formed by a second process of: i) exposing the at least one silicide coating layer to a sufficient amount of at least one oxygen enriched gas, ii) reacting the sufficient amount of oxygen with a sufficient amount of at least one metal element in the silicide coating layer, and iii) forming the at least one blocking layer.

In an embodiment, a surface of the present invention comprises at least one blocking layer that is comprised of at least one of Al2O3, SiO2, Si3N4, and SiC.

### BRIEF DESCRIPTION OF THE SEVERAL VIEWS OF THE DRAWINGS

The present invention will be further explained with reference to the attached drawings, wherein like structures are referred to by like numerals throughout the several views. The drawings shown are not necessarily to scale, with emphasis instead generally being placed upon illustrating the principles of the present invention.

FIG. 1 depicts a schematic illustration of an example of a polysilicon plant such as used and described in the instant invention.

FIG. 2 depicts an embodiment of the present invention.

FIG. 3 depicts a schema to be utilized to form an embodiment of the present invention.

FIG. 4 depicts an embodiment of the present invention.

FIG. 5 depicts an embodiment of the present invention.

FIG. 6 depicts an embodiment of a testing apparatus as described in Example 1 for assessing relative corrosion of alloy samples tested under a variety of experimental conditions.

FIG. 7 depicts the results of an embodiment of corrosion resistance protocols run utilizing a variety of metal alloys, STC, and TCS gases (as silicon source gases).

FIG. 8 depicts the results of an embodiment of corrosion resistance protocols run utilizing a variety of metal alloys, STC, and TCS gases (as silicon source gases).

FIG. 9 depicts the results of an embodiment of corrosion resistance protocols run utilizing a variety of metal alloys, STC, and TCS gases (as silicon source gases), in the presence and/or absence of oxygen.

FIGS. 10A and 10B depict the results of an embodiment of corrosion resistance protocols run utilizing a variety of metal alloys, STC, and TCS gases (as silicon source gases), in the presence and/or absence of oxygen.

FIGS. 11A-11F (before wash) and 12A-12F (after wash) depict the results of an embodiment of corrosion resistance protocols run utilizing a variety of metal alloys, STC, and TCS gases (as silicon source gases), in the presence and/or absence of oxygen. In particular, FIG. 7 depicts the physical appearance of alloys subsequent to exposure to TCS at a reaction vessel temperature of 600 C, followed by exposure to STC at a reaction vessel temperature of 850 C for 14.5 hours.

FIG. 13 depicts the results of an embodiment of corrosion resistance protocols run utilizing a variety of metal alloys, STC, and TCS gases (as silicon source gases).

FIG. 14 is a summary of an embodiment of SEM analysis of various alloys subsequent to subjection of the alloys to the presence and absence of TCS and/or STC at varying temperatures within a reaction vessel.

FIG. 15 shows a piece of a surface in accordance with an embodiment of the present invention.

FIG. 16 shows a composition study of a surface in accordance with an embodiment of the present invention.

FIG. 17 shows a composition study of a surface in accordance with an embodiment of the present invention.

While the above-identified drawings set forth presently disclosed embodiments, other embodiments are also contemplated, as noted in the discussion. This disclosure presents illustrative embodiments by way of representation and not limitation. Numerous other modifications and embodiments can be devised by those skilled in the art which fall within the scope and spirit of the principles of the presently disclosed invention.

### DETAILED DESCRIPTION OF THE INVENTION

Examples of such applications for which the present invention is intended are processes for production/enrichment/distillation of granular polysilicon. Highly pure polycrystalline silicon (polysilicon) is a starting material for the fabrication of electronic components and solar cells. It is obtained by thermal decomposition of a silicon source gas or reduction, with hydrogen, of a silicon source gas.

For the purposes of describing examples of applications of the present invention in processes for production/enrichment/distillation of granular polysilicon, the following terms are defined:

“Silane” means: any gas with a silicon-hydrogen bond. Examples include, but are not limited to, SiH₄; SiH₂Cl₂; SiHCl₃.

“Silicide” means: a compound that has silicon in conjunction with more electropositive elements; in one example, a compound comprising at least a silicon atom and a metal atom; including, but not limited to, Ni₂Si; NiSi; CrSi₂; FeSi₂

“Silicon Source Gas” means: Any silicon-containing gas utilized in a process for production of polysilicon; in one embodiment, any silicon source gas capable of reacting with an electropositive material and/or a metal to form a silicide.

“STC” means silicon tetrachloride (SiCl₄).

“TCS” means trichlorosilane (SiHCl₃).

The process of reducing, with hydrogen, of a silicon source gas is known to those skilled in the art as chemical vapor deposition, CVD (or Siemens process). The chemical vapor deposition of elemental silicon in these CVD reactors takes place on silicon rods, so called thin rods. These rods are heated to more than 1000 C under a metal bell jar by means of electric current and are then exposed to a gas mixture consisting of hydrogen and a silicon source gas, for example trichlorosilane (TCS). As soon as the thin rods have grown to a certain diameter, the process has to be interrupted, i.e. only batch wise operation rather than continuous operation is possible.

Some embodiments of the present invention are utilized to obtain highly pure polycrystalline silicon as granules, hereinafter referred to as “silicon granules”, in fluidized-bed reactors in the course of a continuous CVD process. Some embodiments of the present invention are utilized to obtain highly pure polycrystalline silicon as granules, hereinafter referred to as “silicon granules”, in fluidizedized-bed reactors in the course of or thermal decomposition. Fluidizedized-bed reactors are often utilized, where solid surfaces are to be exposed extensively to a gaseous or vaporous compound. The fluidized bed of granules exposes a much greater area of silicon surface to the reacting gases than is possible with other methods of CVD or thermal decomposition. A silicon source gas, such as HSiCl₃, or SiCl₄, is utilized to perfuse a fluidized bed comprising polysilicon particles. These particles as a result, grow in size to produce granular polysilicon.

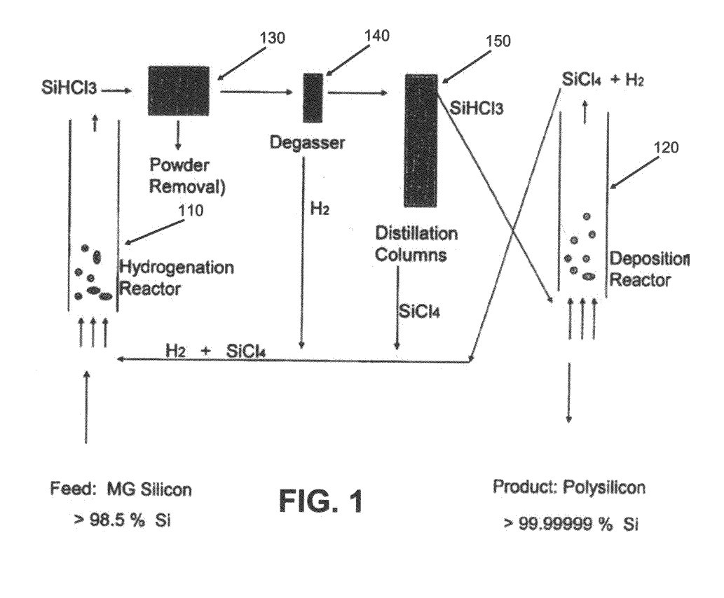

An embodiment of the thermal decomposition of a silicon source gas is shown in FIG. 1. In an embodiment, metallurgical grade silicon is fed into a hydrogenation reactor 110 with sufficient proportions of TCS, STC and H2 to generate TCS. TCS is then purified in a powder removal step 130, degasser step 140, and distillation step 150. The purified TCS is fed into a decomposition reactor 120, where TCS decomposes to deposit silicon on beads (silicon granules) of the fluidized bed reactor. Produced STC and H2 are recycled in to the hydrogenation reactor 110.

Detailed embodiments of the present invention are disclosed herein; however, it is to be understood that the disclosed embodiments are merely illustrative of the invention that may be embodied in various forms. For instance, the disclosure of various embodiments of the present invention for application in processes of silicon deposition serves only as an illustration of the principals of the present invention and some specific applications, but the present invention may also be applied for other conditions (e.g. Siemens process), environments, and/or reactions that may exhibit at least some of characteristics (e.g. thermal stability, reactive inertness, corrosion resistance, etc.) that may be similar to at least one characteristic of the processes associated with purification of silicon.

Further, each of the examples given in connection with the various embodiments of the invention as applied to the silicon purification processes are intended to be illustrative as well, and not restrictive. Further, the figures are not necessarily to scale, some features may be exaggerated to show details of particular components. In addition, any measurements, specifications and the like shown in the figures are intended to be illustrative, and not restrictive. Therefore, specific structural and functional details disclosed herein are not to be interpreted as limiting, but merely as a representative basis for teaching one skilled in the art to variously employ the present invention.

In one embodiment of the present invention, under certain specific conditions of operation, certain metal alloys (for example and without limitation, nickel-chrome-molybdenum alloys and nickel-chrome-cobalt alloys) tend to form a protective metal silicide coating in the presence of certain chlorosilane gases. In some embodiments, the metal silicide coating once formed will maintain its integrity during normal operation of a fluidized bed reactor utilized in a CVD (Siemens) process or in a thermal decomposition process.

Some embodiments of the present invention may provide benefits that may include an ability to operate, for example, silicon-producing reactions at relatively high temperatures to achieve effective reaction rates. Some other embodiments of the present invention may provide benefits that may include an ability to operate, for example, silicon deposition reactions not only at relatively high temperatures to achieve effective deposition rates but also to operate in highly corrosive conditions due to, for example, presence of chlorine component of a silicon source gas.

Some embodiments of the present invention may allow to operate various chemical reactions at suitable temperatures above 200 degrees Celsius. Some embodiments of the present invention may allow to operate various chemical reactions at temperatures above 300 degrees Celsius. Some embodiments of the present invention may allow to operate various chemical reactions at temperatures above 400 degrees Celsius. Some embodiments of the present invention may allow to operate various chemical reactions at temperatures above 500 degrees Celsius. Some embodiments of the present invention may allow to operate various chemical reactions at temperatures above 600 degrees Celsius. Some embodiments of the present invention may allow to operate various chemical reactions at temperatures above 700 degrees Celsius. Some embodiments of the present invention may allow to operate various chemical reactions at temperatures above 800 degrees Celsius. Some embodiments of the present invention may allow to operate various chemical reactions at temperatures above 900 degrees Celsius. Some embodiments of the present invention may allow to operate various chemical reactions at temperatures above 1000 degrees Celsius. Some embodiments of the present invention may allow to operate various chemical reactions at temperatures above 1100 degrees Celsius. Some embodiments of the present invention may allow to operate various chemical reactions at temperatures above 1200 degrees Celsius. Some embodiments of the present invention may allow to operate various chemical reactions at temperatures between 200 degrees Celsius to 1200-2000 degrees Celsius.

Some embodiments of the present invention may use various type of materials in forming the inventive surfaces. For example, some embodiments may include solely metal-based materials. A metal is a chemical element identified as such in the Period Table of the Elements. Metals occupy the bulk of the periodic table, while non-metallic elements can only be found on the right-hand-side of the Periodic Table of the Elements. A diagonal line drawn from boron (B) to polonium (Po) separates the metals from the nonmetals. Most elements on this line are metalloids, sometimes called semiconductors. This is typically due to the fact that these elements exhibit electrical properties common to both conductors and insulators. Elements to the left of this division line are typically called metals, while elements to the right of the division line are called non-metals. The majority of metals have higher densities (the density of a material is defined as its mass per unit volume) than the majority of nonmetals. Metal-based materials include, but are not limited to, materials made of elements, compounds, and/or alloys. An alloy is a mixture of two or more elements in solid solution in which at least one major component is a metal.

For example, some embodiments may include ceramic or glass-ceramic materials, impregnated with metal-based materials, and or a layered combination of ceramic or glass-ceramic materials with metal-based materials. Ceramic are typically composed of inorganic compounds, usually oxides of chemical elements. Ceramic may include non-oxide inorganic materials, such as nitrides, borides and carbides (e.g. silicon carbide and tungsten carbide). Ceramic materials are typically chemically inert, and often capable of withstanding chemical erosion that occurs in an acidic or caustic environment. Ceramics generally can withstand high temperatures ranging to at least 1600 degrees Celsius. Glass-ceramic materials typically share many properties with both non-crystalline glasses and ceramics. They are usually formed as a glass, and then partially crystallized by suitable heat treatment. For example, the microstructure of whiteware ceramics frequently contains both amorphous and crystalline phases so that crystalline grains are embedded within a non-crystalline intergranular phase of grain boundaries.

Such glass ceramics as whiteware have for example an extremely low permeability to liquids. and are therefore used for vessels. In some embodiments, a mixture of lithium and aluminosilicates may yield an array of glass-ceramic materials with thermomechanical properties. Some embodiments made of glass-ceramics-based materials may exhibit characteristics of being impervious to thermal shock. In some embodiments incorporating glass-ceramic, the negative thermal expansion coefficient (TEC) of the crystalline ceramic phase may be balanced with the positive TEC of the glassy phase (e.g. about 70% crystalline ceramic phase in some examples), such glass-ceramic materials, which may be used in some embodiments of the present invention, may exhibit improved mechanical properties and sustain repeated and quick temperature changes up to 800-1500° C.

Some embodiments of the present invention, the inventive surfaces may be formed in a sandwich from of at least two layers, which may be made from the same type of material or different. For example, in some embodiments, the inventive surfaces may be formed from layers of only metal materials; or a combination of ceramic/glass-ceramic materials and metal materials in any desirable sequence of layers that would still achieve the desirable properties of the final inventive surface; or a metal-impregnated ceramic material, or a combination of a metal-impregnated ceramic material and a metal-based material.

In one embodiment of the present invention, several nickel-chrome-cobalt alloys (e.g., alloy 617 and HR-160) are both pressure-vessel-code-allowable at the required design temperature and, if first properly pretreated to form an inert coating, can in and of itself satisfy material-of-construction requirements so as to form a substantially corrosion-resistant vessel utilizable in the presence of halogen and/or halogen derivatives and other highly corrosive materials.

In one embodiment of the present invention, the use of such inertly-coated metal alloys will allow for production of polysilicon from halogenated silicon source gases in a fluidized bed reactor that is constructed from a metal which meets ASME code requirements for pressure vessels. In addition, in one embodiment of the present invention, the use of the inert coating processes and materials of the instant invention will allow for manufacture of an inert coating utilizing a material other than non-chlorinated silane as a feedstock. In one embodiment of the present invention, as non-chlorinated silane is costly and hazardous to use (e.g. pyrophoric), use of the alloys and processes of the instant invention will result in an inertly-coated metal reactor that meets ASME (“The American Society of Mechanical Engineers”) code requirements and is suitable for common chemical production methods, and that is manufactured using safer and more cost effective materials and methods.

In one embodiment, the present invention provides for protective (e.g. inert) coating of a reaction vessel wherein (1) a silicon source gas is introduced into the reaction vessel having a base layer made from a metal alloy, (2) held at a suitable temperature, and (3) wherein the protective coating is deposited/formed on the exposed surface of the base layer of the metal alloy reaction vessel reaction vessel in accordance with the following chemical formula:

4HSiCl₃+(M)→Si(M)+3SiCl₄+2H₂.

In another embodiment, coating a base layer of a metal alloy reaction vessel with a silicon so as to form a silicide coating on the surface of the metal alloy reaction vessel results in a reaction vessel substantially impervious to the formation of metal chlorides and associated corrosion when a corrosive and/or nucleophilic substance (for example, a halogen compound) is subsequently introduced into the reaction vessel.

In one embodiment, the present invention provides for a formation of an in-situ protective (e.g. inert) coating of the base layer of the reaction vessel wherein an element that reacts with a silicon source gas sufficiently migrates from the base layer into the formed in-situ protective layer, reducing a thickness of the base layer.

In one embodiment, any alloy capable of forming a silicide is utilized. In another embodiment, an appropriate alloy may be utilized with or without cladding.

In another embodiment, the alloy is selected from the group consisting of calcium; chromium; cobalt; copper; iron; nickel; titanium; manganese; molybdenum; and/or platinum.

In another embodiment, the alloy utilized has any of the following compositions:

a) HAYNES HR-160 alloy is covered by ASME Vessel Code case No. 2162 for Section VIII Division 1 construction to 816 degrees Celsius and is composed of at least of: Ni 37% (balance, depending of actual used formulation), Co 29%, Cr 28%, Mo 1% (maximum), W 1%(maximum), Fe 2% (maximum), Si 2.75%, and C 0.05%;

b) HAYNES 230 alloy is covered by ASME Vessel Code case No. 2063-2 for construction to 900 degrees Celsius and is composed of at least of: Ni 57% (balance, depending of actual used formulation), Co 5% (maximum), Cr 22%, Mo 2%, W 14% (maximum), Fe 3% (maximum), Si 0.4%, Mn 0.5%, and C 0.1%;

c) HAYNES 617 alloy is composed of at least of: Ni 54% (balance, depending of actual used formulation), Co 12.5% (maximum), Cr 22%, Mo 9%, Al 1.2%, Fe 1%, Ti 0.3%, and C 0.07%.

In another embodiment, the alloy is ASME approved for at least 800 degrees Celsius applications while maintaining sufficient strength.

In another embodiment, a metal alloy utilized may act as a chlorosilane reaction catalyst.

In another embodiment, the chemical composition of the silicide produced by the reaction of an alloy and a silicon source gas may itself be temperature-dependent.

In another embodiment, the chemical composition of the silicide produced by the reaction of an alloy and a silicon source gas may itself be temperature-dependent as follows:

The formation of some embodiments of the inventive surfaces having protective coating that contains Nickel Silicide may be temperature depended as follows:

a) at about 250 degrees Celsius—no formation;

b) at about 350 degrees Celsius—Ni (3) Si, and/or Ni (5) Si (2);

c) at about 450-650 degrees Celsius—Ni (2) Si; and

d) at about 900 degrees Celsius—Ni Si.

In one embodiment, silicon tetrachloride is utilized, alone or in combination with a silicon gas of the composition HSiCl₃.

In one embodiment, silicon tetrachloride is utilized, alone or in combination with a silicon gas of the composition H₂SiCl₂ (dichlorosilane).

In another embodiment, silicon tetrachloride is utilized, alone or in combination with a silicon gas capable of forming a silicide layer when contacting the surface of a metal alloy.

In some embodiments, suitable temperatures, at which TCS is introduced into a reaction vessel or the reaction vessel is held at to form a protective silicide layer, include, but are not limited to, from about 300 degrees Celsius to about 1200 degrees Celsius.

In one embodiment, TCS is introduced to a reaction vessel held at a temperature of about 600 degrees Celsius for a time sufficient to form a silicide coating on the reaction vessel wall by reacting with a metal alloy comprising the reaction vessel wall. In another embodiment, TCS is introduced to a reaction vessel held at a temperature of about 850 degrees Celsius for a time sufficient to form a silicide coating on the reaction vessel wall by reacting with a metal alloy comprising the reaction vessel wall.

In another embodiment, introduction of silicon tetrachloride to a reaction vessel held at a temperature of about 600 degrees Celsius will result in no alloy corrosion or silicon deposition effect.

In another embodiment, introduction of silicon tetrachloride to a reaction vessel held at a temperature of about 850 degrees Celsius will result in substantial alloy corrosion and/or silicon deposition effect.

In another embodiment, introduction of TCS to a reactor vessel will result in formation of a silicide layer on the reactor vessel alloy wall; corrosion of the reactor vessel alloy wall; deposition of a silicon layer on the reactor vessel alloy and/or silicide layer; and/or have no effect, dependent on the temperature of the reactor vessel.

In another embodiment, a gaseous mixture of TCS and STC will assume the physical and temperature-dependent properties of a TCS only composition.

In another embodiment, TCS and/or STC are introduced into a reaction vessel held at a temperature of about 600-850 degrees Celsius.

In another embodiment, TCS and/or STC are introduced into a reaction vessel held at a temperature of about 650-800 degrees Celsius.

In another embodiment, TCS and/or STC are introduced into a reaction vessel held at a temperature of about 500-982 degrees Celsius.

In another embodiment, TCS and/or STC are introduced into a reaction vessel held at a temperature of about 600-850 degrees Celsius.

In another embodiment, TCS and/or STC are introduced into a reaction vessel held at a temperature of about 350-850 degrees Celsius.

In accordance with some embodiments of the present invention, thickness and/or composition of the silicide-containing protective layer depends on a length of time that a reaction vessel surface is exposed to silicon source gases.

In one embodiment, TCS is introduced to a reaction vessel for a time sufficient to form a silicide coating on the reaction vessel wall by reacting with a metal alloy comprising the reaction vessel wall.

In another embodiment, TCS is introduced to a reaction vessel for a time sufficient to form a silicide coating on the reaction vessel wall by reacting with a metal alloy comprising the reaction vessel wall prior to introduction of any silicon tetrachloride into the reaction vessel.

In another embodiment, TCS is introduced to a reaction vessel for a time sufficient to form a silicide coating on the reaction vessel wall by reacting with a metal alloy comprising the reaction vessel wall simultaneously with introduction of silicon tetrachloride into the reaction vessel.

In another embodiment, TCS is introduced to a reaction vessel for a time sufficient to form a silicide coating on the reaction vessel wall by reacting with a metal alloy comprising the reaction vessel wall. TCS and STC are then simultaneously introduced into the reaction vessel.

In another embodiment, the silicon/silicide coating buildup on the alloy wall of the reactor may be controlled by surface attrition and/or by periodic thermal and/or chemical treatment.

In another embodiment, prior to an introduction of silicon source gases, a base layer of a wall of the reaction vessel is exposed to an oxygen enriched gas (e.g. air) at a sufficient temperature and for a sufficient time to prepare a surface of the base layer to an exposure with a silicon source gas. In some embodiments, such oxygen priming of the base layer may result in an increased affinity of the formed protective silicide layer to the base layer during an operation of the reaction vessel. In some embodiments, such oxygen priming is done at about 900 degrees Celsius for about 24 hours.

In one embodiment, a silicide layer is formed wherein the silicide layer substantially prevents corrosion of the underlying alloy and/or metal.

In another embodiment, a silicide layer is formed wherein the silicide layer substantially prevents leaching of contaminants from the underlying alloy and/or metal to the interior of the reaction vessel.

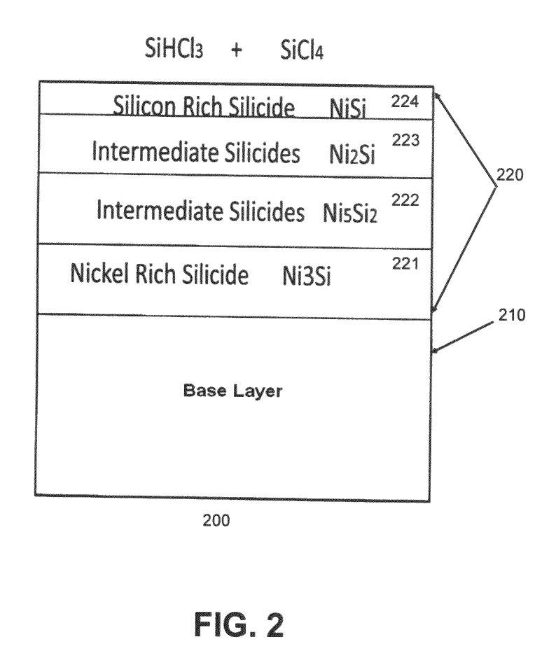

In another embodiment, FIG. 2 shows (without limitation) that the inventive surface 200 is formed in accordance with the invention when silicide-reactive element (e.g. Ni) contained within and/or on a surface of a base layer 210 reacts with silicon source gases to form a protective coating 220. FIG. 2 shows that in some embodiments, the protective coating 220 may be composed of more than a single silicide layer and each silicide layer (221-224). In some embodiments, each silicide layer (221-224) may be composed of several silicide compounds (of the same or different silicide-forming elements).

Moreover, in some embodiments, the base layer 210 may be comprised of a single layer of metal-based material or ceramic/glass-ceramic-based material that has at least a portion of the base layer 210 that contains at least one element that would react with silicon source gases to produce the protective coating 220.

Further, in some embodiments, the base layer 210 may be a sandwich of layers of different types materials but having at least a portion of at least one of the layers, which would be exposed to silicon source gases, to contain at least one element that would react with silicon source gases to produce the protective coating 220.

In some embodiments, amount and disposition of Ni (i.e. a silicide-forming element) in the base layer define characteristics of the silicide layer(s) within the protective coating 220.

In some embodiments, as the protective coating 220 is being formed (in-situ), a thickness of the base layer 210 is reduced due to migration of the silicide-forming element(s) from the base layer into the protective coating 220. In one example, the base layer 210 having original thickness of about a half inch and containing a silicide-forming element in a suitable concentration, upon being exposed to silicon source gas, forms the protective layer of about 200-400 nm after the base layer 210 is being exposed for 24 to 48 hours to silicon source gas.

In some other embodiments, the protective coating 220 has a thickness that varies from about 50 micron to at least 400 micron (10̂−6 m). In another embodiment, as an overall thickness of the inventive surface increases, the original thickness of the base layer 210 is reduced in the inventive process.

In some embodiments, a thickness of the protective coating 220 dependents on a suitable concentration of the silicide-forming element(s) and a suitable time that the base layer 210 is exposed to silicon source gas.

In some embodiments, after an original thickness of the base layer 210 is reduced due to a formation of silicide to a thickness at which it is deemed the reaction vessel is no longer suitable for its intended purpose, the reaction vessel is de-commissioned. In an embodiment, a reaction vessel is decommissioned when a half inch base layer is reduced by more than about a sixteenth of an inch.

In another embodiment, the relative thickness, stability, and/or atomic composition of the silicide layer is assessable utilizing scanning electron microscopy (SEM) and/or other relevant analysis methods, such as EDAX (Energy Dispersive X-Ray Analysis).

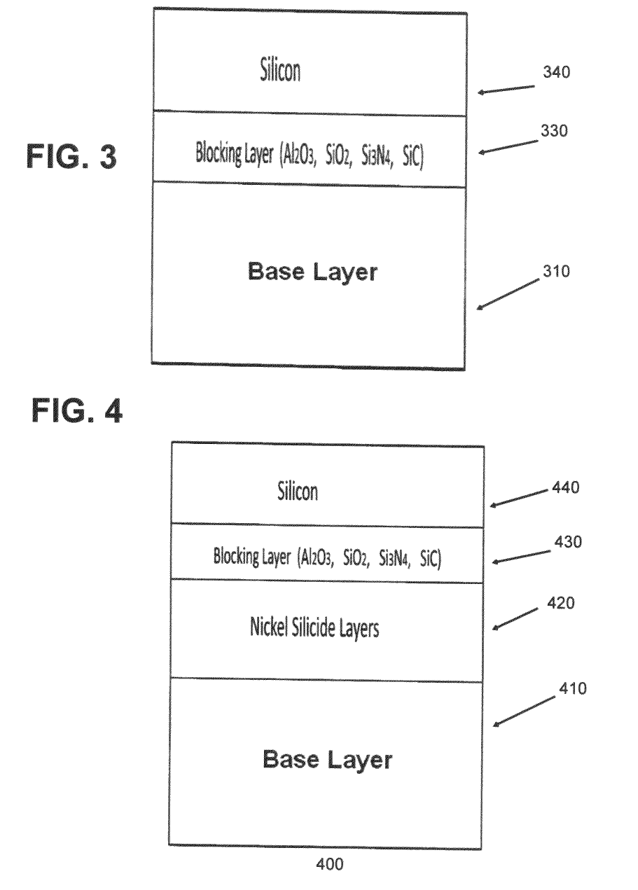

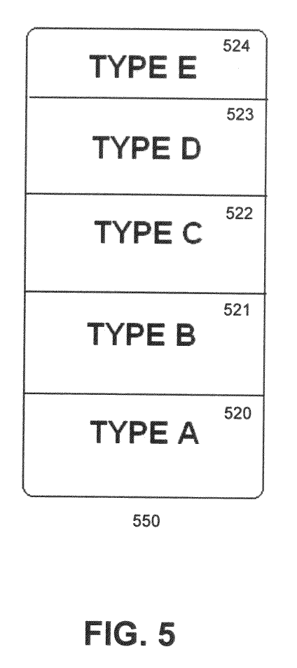

In another embodiments, as shown in FIGS. 3 and 4, the protective coating(s) of surfaces of the present invention may also include at least one blocking layer 330,430 (including, but not limited to, Al2O3; SiO2; SiN3; and/or SiC). In some other embodiments, the protective coating(s) of surfaces of the present invention may also include at least one blocking layer 330, 430 and a silicon layer 340, 440. The at least one blocking layer 330, 430 is formed when the silicide layer 420 and/or a base layer 310, 410 is exposed to an oxygen enriched gas (e.g. air) at a sufficient temperature and for a sufficient time.

In some embodiments, blocking layer(s) is (are) deposited or coated over silicide layer(s) by any suitable mechanical, chemical, or electrical means (e.g. CVD (e.g. aluminizing), plating, etc).

In some embodiments, the inventive surfaces of the present invention include alternate blocking layers of different compositions and/or chemical/mechanical characteristic(s) to be positioned between the silicide layer 420 and the silicon layer 440.

In some embodiments, the formed blocking layer(s) 430 cure(s)/seal(s) silicide layer(s) 420 so that an overall affinity of a protective coating to the base layer 410 is improved. In some embodiments, the presence of the blocking layer 430 may prevent flaking of the protective coating and contaminating with flakes a chemical reaction occurring in a reaction vessel. In some embodiments, the blocking layer(s) 430 prevents flaking off of the protective coating (flakes) during a cooling period of a reaction vessel. In some embodiments, a silicide layer 320 is only exposed to an oxygen enriched gas (e.g. air) before a reaction vessel is cooled after main reaction(s) for which the reaction vessel is designed has(ve) been completed.

In some embodiments, surfaces of the present invention are also exposed to an oxygen enriched gas (e.g. air) at a suitable temperature prior to the reaction vessel is being again exposed to higher temperatures after a cooling period. In some embodiments, surfaces of the present invention are design to withstand continuous substantial fluctuations in temperatures to which they are exposed to (e.g. from room temperature to about 1200 degrees Celsius, from 100 degrees Celsius to about 850 degrees Celsius, etc.) without significant loss of their desirable anti-corrosion and other properties.

In another embodiments, as shown in FIGS. 3 and 4, the silicon layer 340, 430 is formed/deposited when silicon is generated by the silicon producing reactions (e.g. reduction or thermal decomposition reactions) during actual operation of a reaction vessel (see FIG. 1), is produced as a by-product during a formation of the protective silicide layer, and/or generated in/delivered into the reaction vessel by some other suitable means. In some embodiments, the silicon layer 340, 440 is formed from a silicon that generates during the decomposition reaction such as the one, for example, shown in FIG. 1.

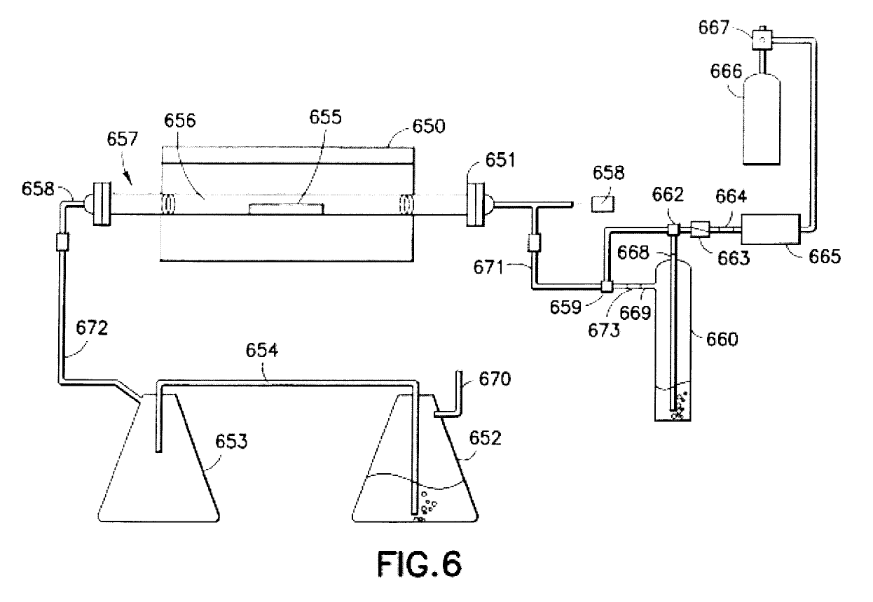

Referring to FIG. 4, showing a portion 550 of an internal surface of a reaction vessel. In some embodiments of the present invention, as shown by FIG. 5, manipulating at least one of the following conditions may produce the inventive surface 550 that would have areas (520-524) of the protective coating having the same and /or different characteristics (Types A-E):

1) a composition and disposition of silicide-forming element(s) in a base layer;

2) temperature at which the base layer is exposed to silicon source gases;

3) a length of the exposure; and

4) a presence of a blocking layer.

For example, in some embodiments, manipulating at least one of the above referenced conditions may result in having more protective coating in a reaction area of a reaction vessel and have less protective coating in other area which are subject to less harsher environment (e.g. lower temperature, lesser corrosion reagents, etc.)

The following discussion relates to some exemplary embodiments of the present invention.

### EXPERIMENT 1

### Protocol for Assessing Relative Corrosion of an Alloy Exposed to Halogenated Silicone Source Gases

One example of a corrosion test utilized to determine the relative effectiveness of the alloy/inert layer combination in resisting corrosion is set forth below.

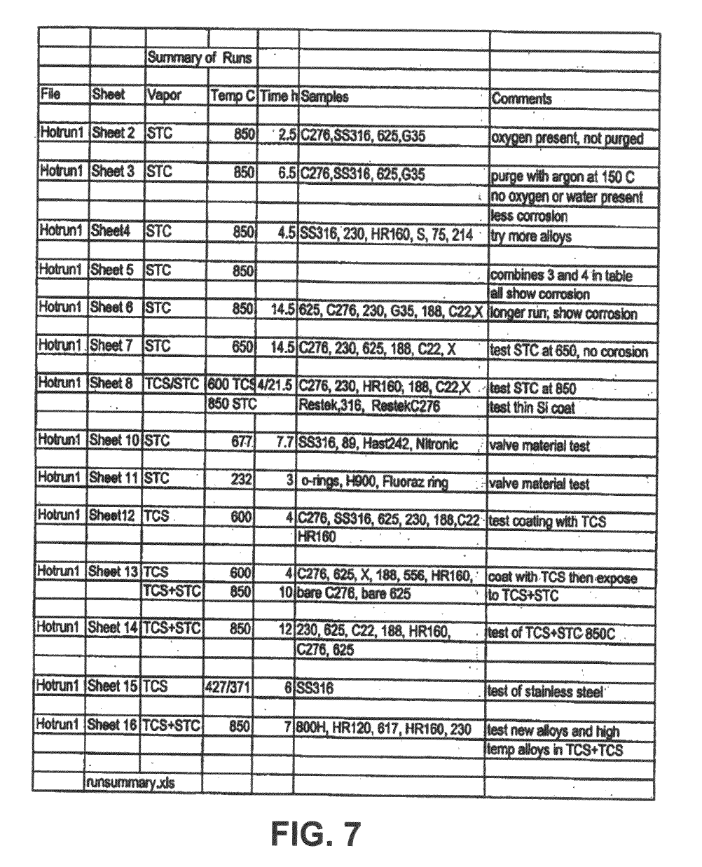

An apparatus such as that depicted in FIG. 6 is utilized. In one embodiment, the furnace 650 is a Thermcraft single zone model XST-3-0-36-1C with a 3 inch ID (230 volts 6780 watts). The tube 656 is 36 inches×3 inches with a volume of about 5 L with the end caps 651, 657. The samples sit in a quartz boat 655. Get a tare weight for the empty bubbler 660 or note the tare weight written on the tag on the bubbler 660. Fill the bubbler 660 with 150-200 ml of silicon tetrachloride. The bubbler 660 is filled by adding 60 ml of chlorosilane using a 60 ml syringe and ⅛ inch Teflon tubing several times.

If the bubbler 660 is filled, check the weight of chlorosilane. There should be at least 50 grams of chlorosilane (TCS or STC).

Weight the bubbler 660 to determine the amount of silicon tetrachloride that was added or was in the bubbler at the start time of the run. Connect the bubbler 660 back so the top end 668 goes to the argon cylinder 666 and the exit end 669 goes to the tube through a 3-way valve 659.

Fill the trap 652, 653 with 900 ml of 25% sodium hydroxide (450 gm of 50% NaOH mixed with 450 gm of water). Put the outlet of the tube 654 below the liquid level in the scrubber 652, 653. Make sure the exhaust 670 from the scrubber 652 goes out to the hood exhaust.

Record the initial mass of 3-5 metal coupons and their identity. Place them in a boat 655 at the center of the tube furnace 650. Seal both ends 651, 657 of the tube 656 with the viton O-ring and the clamp.

Start the flow of Argon at 200 ml/minute and heat the furnace 650 to 150 degrees Celsius. Run under these conditions for 1 hour to remove the oxygen and water from the tube.

Check to make sure that the system is sealed and that there are bubbles coming out of the scrubber 652, 653. Periodically check that the exit line 672 to the scrubber 653, 652 is not plugged. If it is plugged, cut off the plug and make sure the scrubber 652, 653 is working.

Reduce the flow of argon to 8 ml/minute and heat the oven 650 gradually to 850 degrees Celsius over an hour. Make sure that the pressure on the outlet of the gas regulator 663 does not go over 8 psig. If the outlet to the tube plugs, this is the pressure (8 psig) to which the tube will rise.

Turn on the bubbler 560 to deliver chlorosilane using the three way valve 659. Turn on the exit valve first and then the entrance valve. Confirm that there is flow coming out of the scrubber 652, 653 as indicated by bubbles. Note the time that the chlorosilane started to flow.

Periodically during the run check that the outlet line to the scrubber 652, 653 is not plugged and the proper flow of 8 ml per minute is going through the scrubber 652, 653 to the exhaust.

When the run is over, turn off the furnace 550. Also, turn the three way valves 662 on the bubbler 660 so that they deliver argon. Turn the inlet side first and then the outlet end. Raise the argon flow to 200 ml per minute for 30 minutes to purge out the tube 556 to remove the chlorosilane. Make sure the scrubber 652, 653 does not plug.

Reduce the flow of gas to 8 ml per minute and let the furnace 650 cool overnight The next morning when the furnace has cooled, make sure the scrubber 652, 653 is not plugged. Cut out the plug if necessary. Turn off the argon flow.

Open the exit end of the tube 656 and draw out the boat 655 with the samples.

Place the samples in a cup of water and stir to remove insoluble material (iron chloride or nickel chloride). Stir for five minutes. Then move to another cup until there is no more color or material coming off of the samples. (green is the color of nickel chloride and blue is the color of cobalt (II) chloride).

Dry the samples and weight them to the nearest milligram. Determine the weight change and the percent weight change.

Clean out any residue in the ends of the tubes. The red or yellow material that collects on the end of the tube is silicon (II) oxide that quickly oxidizes to silicon (IV) dioxide. On exposure to air. If the tube 656 has been properly purged free of oxygen before the runs start, there should be very little silicon oxide residue.

The system is now ready to start another run by going to Step 1 above.

In another embodiment, a vapor pressure of STC in the bubbler 660 is 0.27 atmosphere (atm). In another embodiment, a vapor pressure of TCS in the bubbler 660 is 0.66 atmosphere (atm). In another embodiment, the test apparatus may further consist of shut off valves 664, 673, and mass flow controller 665. In another embodiment, certain components of the test apparatus are connected by Teflon tubing 654, 671, and 672.

### EXAMPLE 2

### Utilization of Certain Alloy and Halogenated Silicon Source Gases in an Assessment of Relative Corrosion

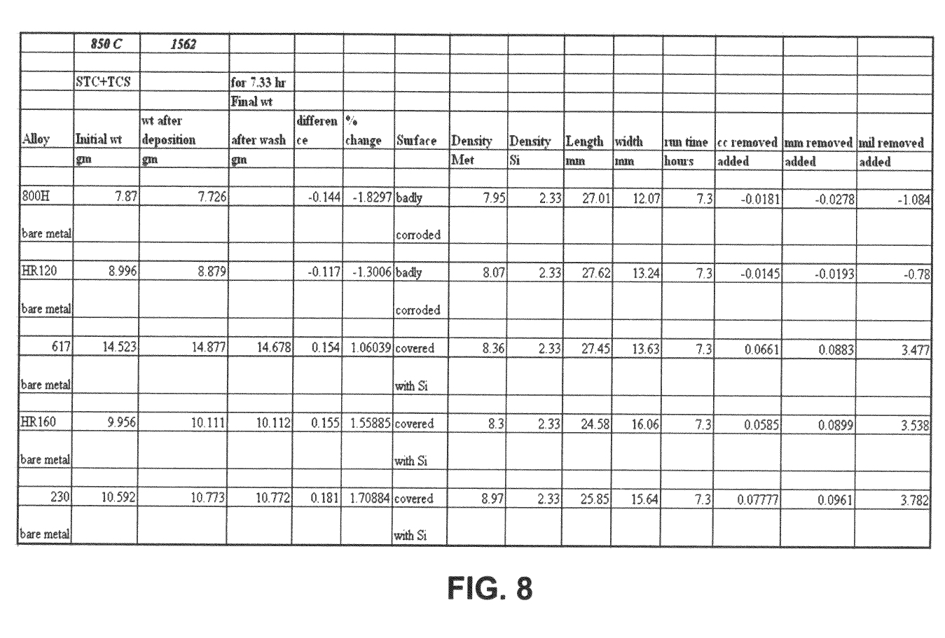

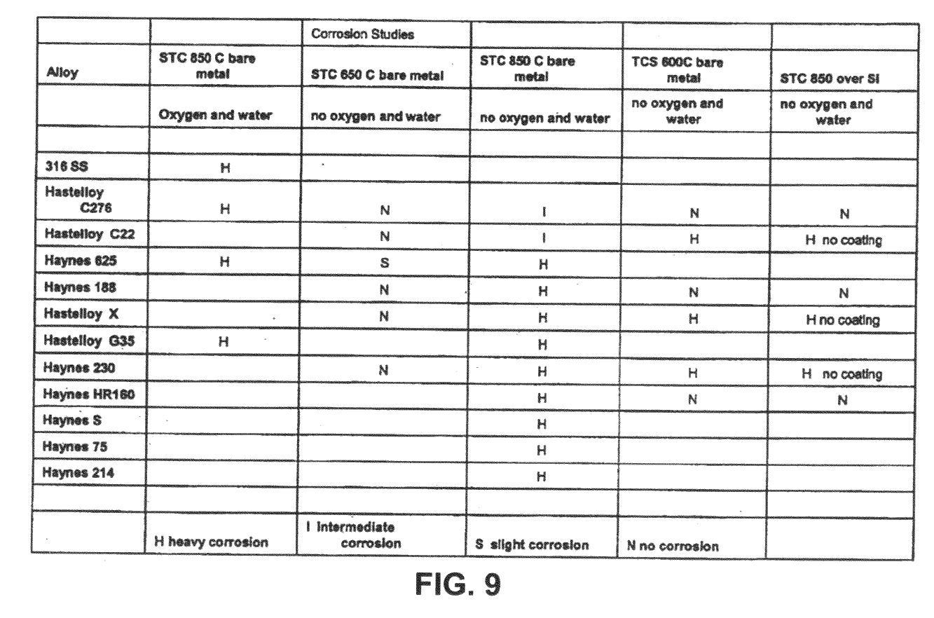

FIGS. 7 and 8 demonstrate corrosion resistance data wherein several alloys were exposed to chlorosilanes at 850 degrees Celsius.

From several corrosion test runs depicted in FIGS. 7 and 8, it is clear that using certain alloys in conjunction with treatment with certain silicon source gases capable of reacting with said alloys to form silicide coatings facilitates manufacture of a reactor that could withstand the conditions that one would encounter in a TCS/polysilicon deposition reactor (temperatures at 850 degrees Celsius and presence of chlorosilanes).

### EXAMPLE 3

### Utilization of Certain Alloy and Halogenated Silicon Source Gases in an Assessment of Relative Corrosion, in Experimental Conditions with the Presence/Absence of Oxygen

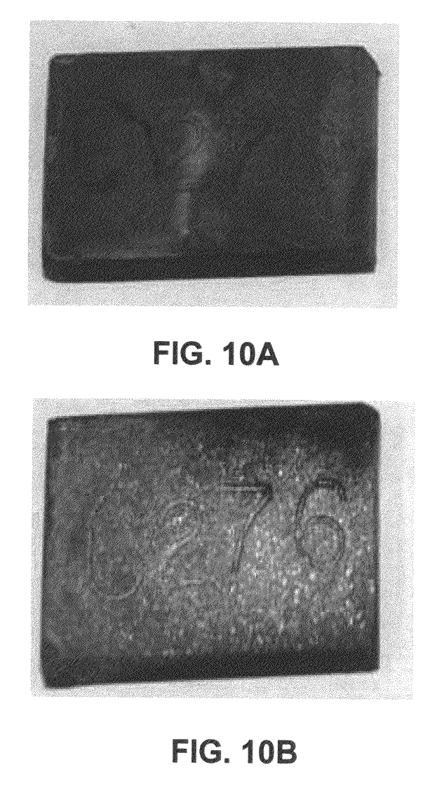

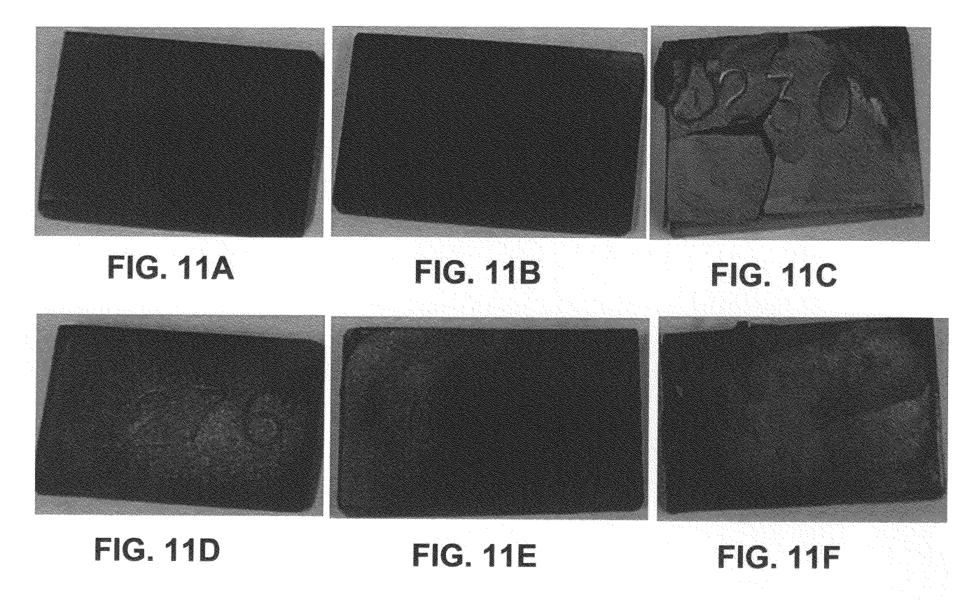

FIGS. 9 and 10 demonstrate the use of various alloys in a corrosion resistance protocol such as that illustrated in Example 1, utilizing various permutations of alloy materials; silicone source gases capable of forming silicides with said alloys; and interior reactor conditions with and without the presence of oxygen. As demonstrated in FIG. 9, alloys in an oxygenated environment without silicide formation exposed to silicon tetrachloride demonstrated corrosion. Alloys in an oxygen-free environment exposed to silicon tetrachloride demonstrated corrosion, albeit to a lesser degree. Alloys reacting with a TCS silicone source gas so as to form a silicide on the surface of the alloy prior to introduction of a silicon tetrachloride demonstrated reduced corrosion an deposition of silicon on the silicide layer.

Referring to FIGS. 10A and 10B, FIG. 10A shows a corrosion of a plate made from C276 alloy after the plate was exposed for 14 hours to STC at 850 degrees Celsius, which was not pre-treated with TCS to form a protective silicide coating. In contract, FIG. 10B shows absence (or a significant lesser degree) of a corrosion of a plate made from C276 alloy after the plate was exposed for 14 hours to STC at 850 degrees Celsius because the plate was pre-treated with TCS to form a protective silicide coating.

### EXAMPLE 4

### Utilization Of Certain Alloy and Halogenated Silicon Source Gases in an Assessment of Relative Corrosion, in Experimental Conditions with the Presence/Absence of Oxygen

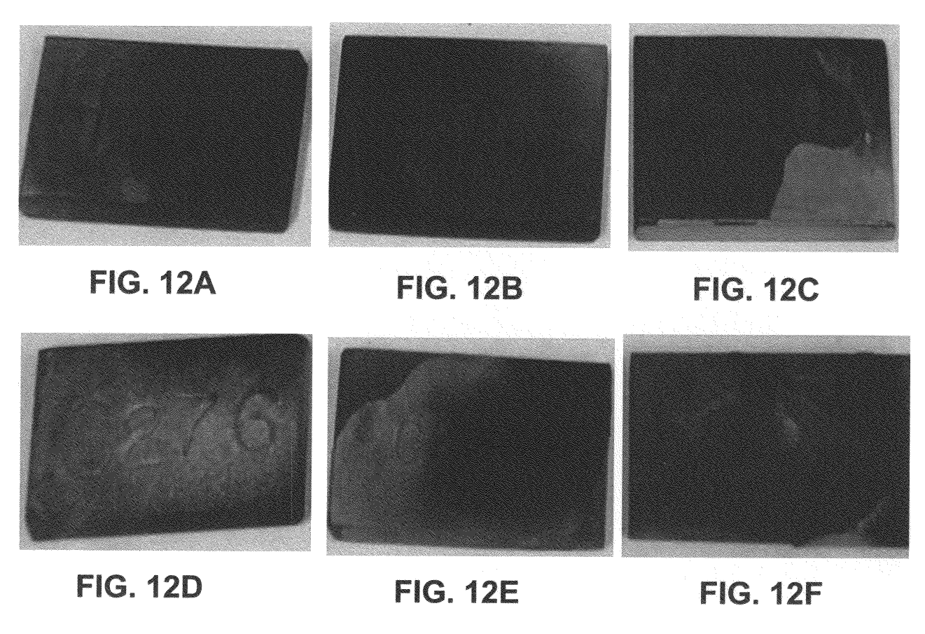

FIGS. 11A-11F (pre-wash) and 12A-12F (post-wash) demonstrate the use of various alloys in a corrosion resistance protocol such as that illustrated in Example 1, utilizing various permutations of alloy materials; silicone source gases capable of forming silicides with said alloys; and interior reactor conditions with and without the presence of oxygen.

FIGS. 11A and 12A corresponds embodiments with a base layer made from alloy H160.

FIGS. 11B and 12B corresponds embodiments with a base layer made from alloy 188.

FIGS. 11C and 12C corresponds embodiments with a base layer made from alloy 230.

FIGS. 11D and 12D corresponds embodiments with a base layer made from alloy C276.

FIGS. 11E and 12E corresponds embodiments with a base layer made from alloy C22.

FIGS. 11F and 12F corresponds embodiments with a base layer made from alloy X.

As demonstrated in FIGS. 11A-11F and 12A-12F, certain alloys exposed to silicon tetrachloride demonstrated corrosion. Alloys reacting with a TCS silicone source gas so as to form a silicide on the surface of the alloy prior to introduction of a silicon tetrachloride for 14 hours at 850 degrees Celsius demonstrated deposition of silicon on the silicide layer and reduced corrosion.

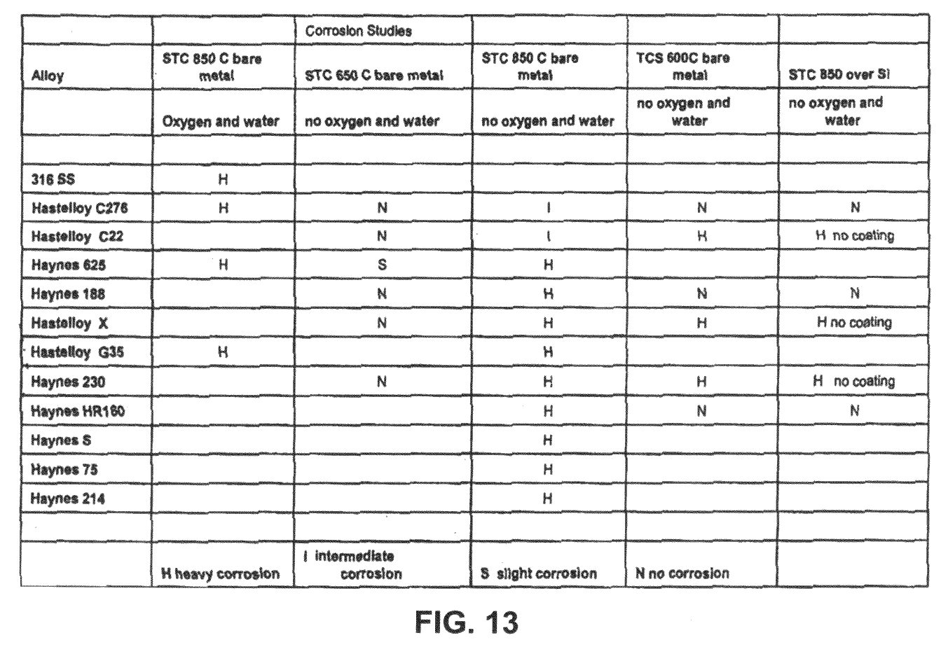

FIG. 13 depicts the results of corrosion resistance protocols run for embodiments utilizing a variety of metal alloys, STC, and TCS gases (as silicon source gases).

Below is a summary of the behavior of certain alloys used as a base layer in some embodiments of the present invention, in the presence and absence of TCS and/or STC at varying temperatures within a reaction vessel.

a) alloys C276, 625, 188, and HR 160 were able to form silicide-coating (textured coating) in presence of silicon tetrachloride and thus would prevent corrosion of an embodiment at 600 degrees Celsius:

HSiCl3+M→Si (coating)+SiCl4+H2+M (Si coats)

b) alloys 230, C22, X, and 556 were unable able to form silicide-coating in presence of silicon tetrachloride and would not prevent corrosion of an embodiment at 600 degrees Celsius:

HSiCl3+M→H2+MCl+Si (coating flakes off)

c) alloys C276, 230, 617, 625, and HR 160 were able to form at least some silicide-coating (uneven specular coating) in presence of silicon tetrachloride and thus would prevent corrosion of an embodiment at 850 degrees Celsius:

HSiCl3+SiCl4+M→Si+SiCl4+H2+M (Si coats)

b) alloys 800H, C22, 188, and HR120 were unable able to form silicide-coating in presence of silicon tetrachloride and would not prevent corrosion of an embodiment at 850 degrees Celsius:

### EXAMPLE 5

### Corrosion Versus Coating Dependent on Mixture of STC, TCS and Temperature of Reaction Vessel

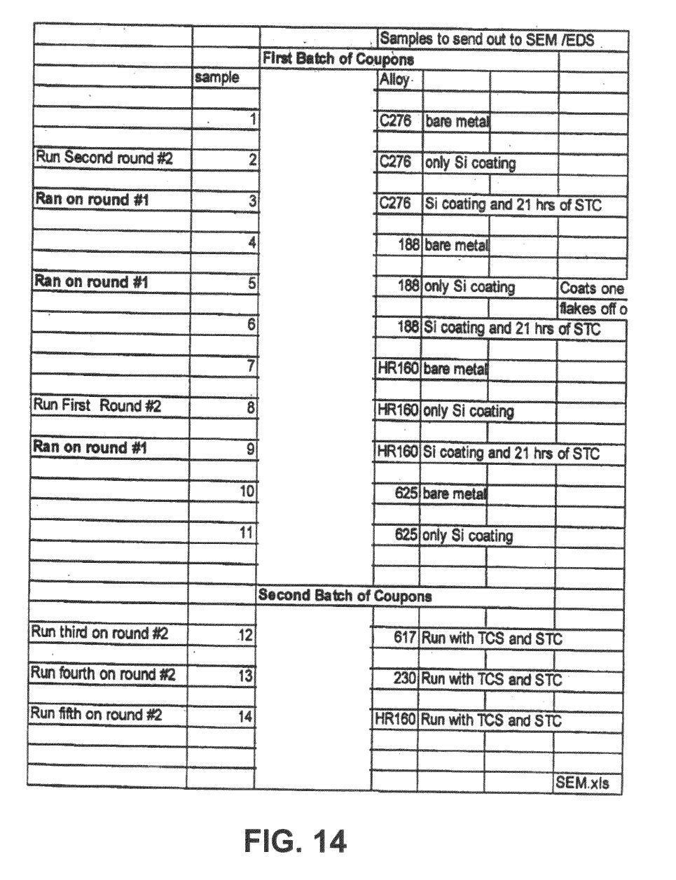

FIG. 14 is one embodiment of the present invention, depicting the behavior of certain alloys in the presence and absence of TCS and/or STC at varying temperatures within a reaction vessel. As demonstrated in FIG. 14, (a) use of TCS in a reaction vessel at 600 degrees Celsius wherein the alloy used for the reaction vessel wall is of a particular composition may result in a silicide coating of the alloy reaction vessel walls hat substantially prevents corrosion. (b) Use of TCS in a reaction vessel at 600 degrees Celsius wherein the alloy used for the reaction vessel wall is of a different composition may result in a silicide coating of the alloy reaction vessel walls that prevents corrosion/creates a durable silicide inert layer to a lesser degree. (c) Use of TCS in a reaction vessel at 850 degrees Celsius wherein the alloy used for the reaction vessel wall is of the same composition as (a) above may result in a silicide coating of the alloy reaction vessel walls that prevents corrosion/creates a durable silicide inert layer to a lesser degree. (d) Use of TCS in a reaction vessel at 850 degrees Celsius wherein the alloy used for the reaction vessel wall is of a different composition than that of (a) and (c) above may result in a silicide coating of the alloy reaction vessel walls that prevents corrosion/creates a durable silicide inert layer to a lesser degree.

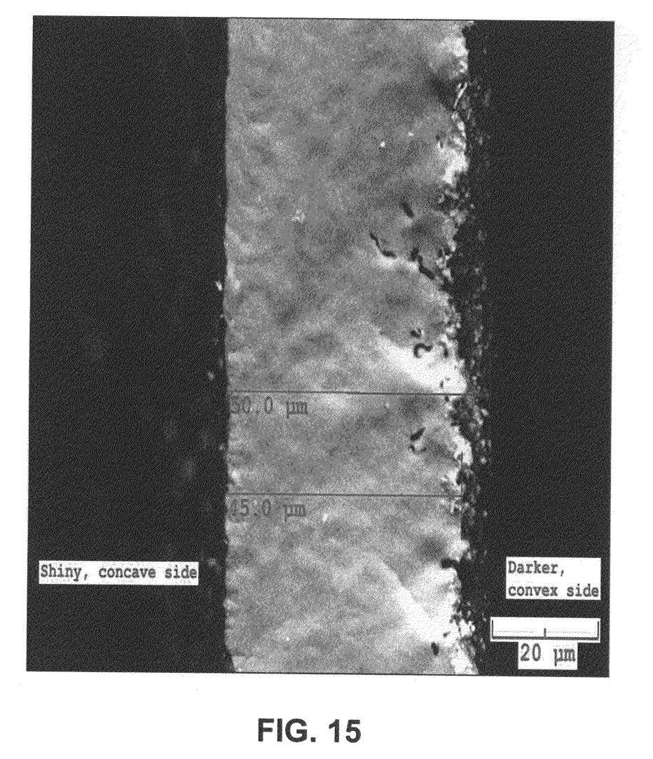

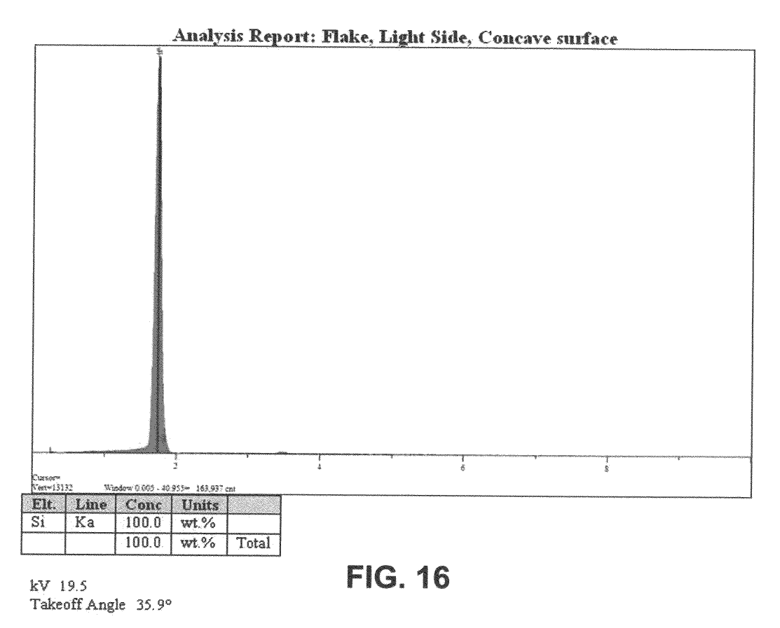

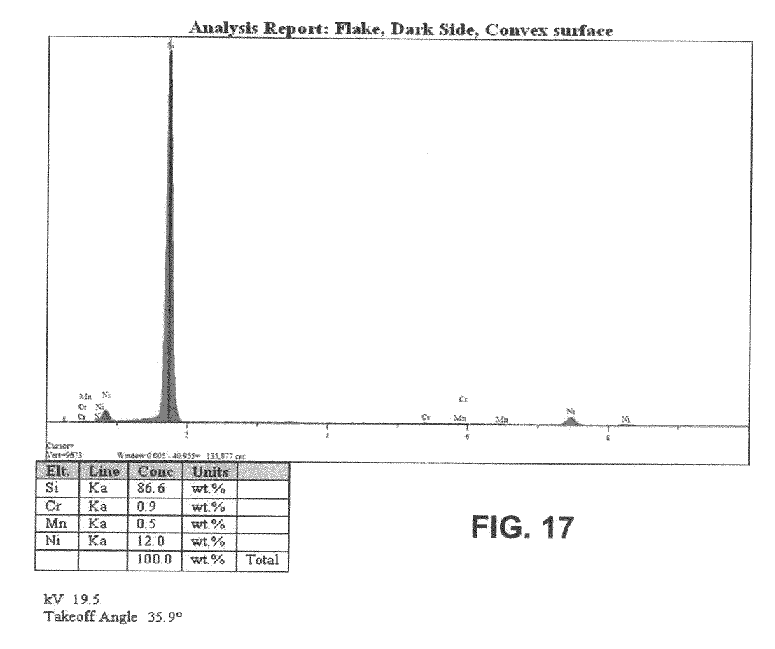

Referring to FIGS. 15-17, representing data regarding some embodiments of the present invention. FIG. 15 shows a piece of material that came off of a reaction vessel during its operation and/or after the reaction vessel is being cooled. FIG. 16 shows Edax result of a study of a composition of a concave side (inner side, which is away (opposite) from the base layer—i.e. directly exposed to reaction environment) of the piece of “flaked off” material in FIG. 15. FIG. 17 shows Edax result of a study of a composition of a convex side (outer side, which is attached to the silicide layer of the reaction vessel) of the piece of “flaked off” material in FIG. 15. FIGS. 15-17 demonstrate that a silicon inner layer is produced and it grows from the silicide layer that coats the base metal. In some embodiments, the oxide treatment and a blocking layer may improve the sufficient affinity of such material in FIGS. 15-17 to a reaction vessel.

While a number of embodiments of the present invention have been described, it is understood that these embodiments are illustrative only, and not restrictive, and that many modifications and/or alternative embodiments may become apparent to those of ordinary skill in the art. For example, any steps may be performed in any desired order (and any desired steps may be added and/or any desired steps may be deleted). Therefore, it will be understood that the appended claims are intended to cover all such modifications and embodiments that come within the spirit and scope of the present invention.

We claim:

1. A surface, comprising:
at least one base layer, wherein the at least one base layer contains at least one silicide-forming metal element; and
at least one silicide coating layer, wherein the at least one silicide coating layer is formed by a process of:
i) exposing the at least one base layer having a sufficient amount of the at least one silicide-forming metal element to a sufficient amount of at least one silicon source gas having a sufficient amount of silicon element,
ii) reacting the sufficient amount of the at least one silicide-forming metal element with the sufficient amount of silicon element, and
iii) forming the at least one silicide coating layer.

2. The surface of claim 1, wherein at least one first part of the at least one base layer is sufficiently designed to form at least one first portion of the at least one silicide coating and at least one second part of the at least one base layer is sufficiently designed to form at least one second portion of the at least one silicide coating.

3. The surface of claim 1, wherein the at least one silicide coating is sufficiently designed to withstand a substantial chemical corrosion at temperatures above 300 degrees Celsius.

4. The surface of claim 1, wherein the at least one base layer is comprised of a ceramic material.

5. The surface of claim 1, wherein the at least one base layer is comprised of a glass ceramic material.

6. The surface of claim 1, wherein the at least one base layer is comprised of at least one of Al, C, Ca, Co, Cr, Cu, Fe, Mo, Si, Nb, Ni, Pt, Ti, and W.

7. The surface of claim 1, wherein a composition of the at least one silicide coating depends on a temperature at which the at least one base layer is exposed to the at least one silicon source gas.

8. The surface of claim 1, wherein the at least one silicon source is comprised at least one of HₓSi_{y}Cl_{z}, wherein x, y, and z is from 0 to 6.

9. A surface, comprising:
a) at least one base layer, wherein the at least one base layer contains at least one silicide-forming metal element;
b) at least one silicide coating layer, wherein the at least one silicide coating layer is formed by a first process of:
i) exposing the at least one base layer having a sufficient amount of the at least one silicide-forming metal element to a sufficient amount of at least one silicon source gas having a sufficient amount of silicon element,
ii) reacting the sufficient amount of the at least one silicide-forming metal element with the sufficient amount of silicon element, and
iii) forming the at least one silicide coating layer; and
c) at least one blocking layer.

10. The surface of claim 9, wherein the at least one blocking layer is formed by a second process of:
i) exposing the at least one silicide coating layer to a sufficient amount of at least one oxygen enriched gas,
ii) reacting the sufficient amount of oxygen with a sufficient amount of at least one metal element in the silicide coating layer, and
iii) forming the at least one blocking layer.

11. The surface of claim 9, wherein the at least one blocking layer is comprised of at least one of Al₂O₃, SiO₂, Si₃N₄, and SiC.
